(19) United States
(12) Patent Application Publication
(10) Pub. No.: US 2022/0313545 A1
(43) Pub. Date: Oct. 6, 2022

(54) HEAD MASSAGER

(71) Applicant: Hefei Hezheng Medical Technology Co.,Ltd, Anhui (CN)

(72) Inventors: Zhiwei Han, Anhui (CN); Yongwei Han, Anhui (CN)

(73) Assignee: Hefei Hezheng Medical Technology Co.,Ltd, Anhui (CN)

(21) Appl. No.: 17/415,746

(22) PCT Filed: Apr. 29, 2021
(86) PCT No.: PCT/CN2021/091020

§ 371 Date: Jun. 18, 2021

(30) Foreign Application Priority Data
Oct. 16, 2020 (CN) 202011108400.6

(51) Int. Cl. A61H 23/02

(52) U.S. Cl. CPC A61H 23/02; A61H 2205/02; A61H 2201/5002

(57) ABSTRACT

A head massager includes a base component and a first massage component. The first massage assembly includes a plurality of first massage units, each first massage unit has a first connecting part and a first massage part, one end of the first connecting part is fixed to the side edge of the base assembly, and the other end of the first connecting part is connected to the first massage part. A first vibration source is encapsulated in each first massage part, and the plurality of first massage units are arranged in an annular array relative to a central axis of the base assembly. When a head is located among the first connecting parts, the first massage parts are attached to the head together. In the head massager proposed in the present application, each first massage part has an independent first vibration source for driving.

### CROSS-REFERENCE TO RELATED APPLICATION

This application claims the priority benefit of China application no. 202011108400.6 filed on Oct. 16, 2020 and entitled “head massager”. The entirety of each of the above mentioned patent applications is hereby incorporated by reference herein and made a part of this specification.

### BACKGROUND

Technical Field

The application relates to the field of massage appliances, and in particular, to a head massager.

Description of Related Art

Head massage can promote blood circulation in the brain, activate cell vitality and brain nerves, and help regulate the function of the cerebral cortex. It can eliminate fatigue, has a certain relief effect on dizziness, headache, insomnia and other symptoms, and is conducive to the normal circulation of the whole body jobs. Most of the existing head massagers use a common general vibrator to drive all the massage claws to work, and each massage claw cannot vibrate independently, which will produce a resonance effect, causing people to feel discomfort like dizzy, and the massage effect is not ideal.

### SUMMARY

In order to solve the technical problems existing in the background art, the present application proposes a head massager.

The present application provides a head massager used for head massage. The head massager comprises a base component and a first massage component. The first massage assembly comprises a plurality of first massage units, and each of the first massage units has a first connecting part and a first massage part. One end of the first connecting part is fixed to a side edge of the base assembly, and the other end is connected to the first massage part. A first vibration source is encapsulated in the first massage part, and the plurality of first massage units are arranged in an annular array relative to a central axis of the base assembly. When the head is adapted to be located among the first connecting parts, the plurality of first massage parts of the first massage units fit and attach to the head together.

Wherein, when the head is located among the plurality of first connecting parts, a curved surface of each of the first connecting parts attaches the head.

Wherein, the base assembly comprises a shell assembled from an upper shell body and a lower shell body, and a second massage assembly. The second massage assembly comprises a plurality of second massage units, and each of the second massage units has a second massage part and a second connecting part connected to the second massage part. A second vibration source is encapsulated in the second massage part. The lower shell body has a number of through holes, the second connecting part is encapsulated and fixed in the shell, and the second massage part protrudes out from the shell, when the head is located among the plurality of first connecting parts, the second massage parts fit and attach a top of the head.

Wherein, the first connecting part comprises a hose and a support rod, the support rod is provided with a groove, and the hose can be set on the support rod suitably.

Wherein, the support rod is made of elastic material.

Wherein, the second massage unit is made of soft material.

Wherein, the first massage part has a massage surface inclined to the head, and the inclination angle range between the massage surface and the central axis of the base assembly is 5-10 degrees.

Wherein, a control component fixed on the base component is also comprised, the control component is electrically connected with the plurality of first vibration sources for controlling the plurality of first vibration sources to work independently.

In the head massager proposed in the present application, each first massage part has an independent first vibration source for driving, and which working states do not affect each other, the cooperation of the plurality of first massage parts can achieve the effect of full massaging the head; the vibration strength and massage rhythm of each first massage part can be adjusted, which can be applied to users with different sensitivities to massage.

### BRIEF DESCRIPTION OF THE DRAWINGS

FIG. 1 is a schematic view of a head massager according to the present application.

FIG. 2 is a schematic view of a first massage unit of the head massager according to the present application.

FIG. 3 is a cross-sectional view of the first massage unit according to the present application.

### DESCRIPTION OF THE EMBODIMENTS

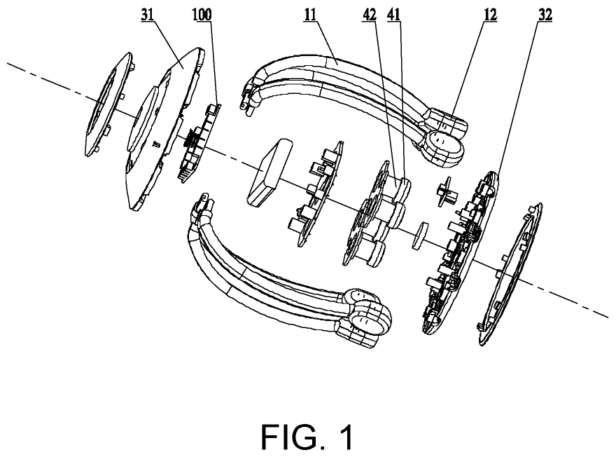

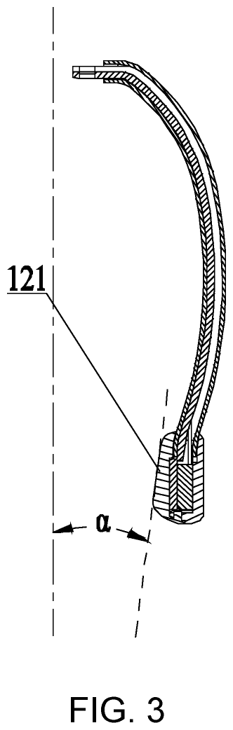

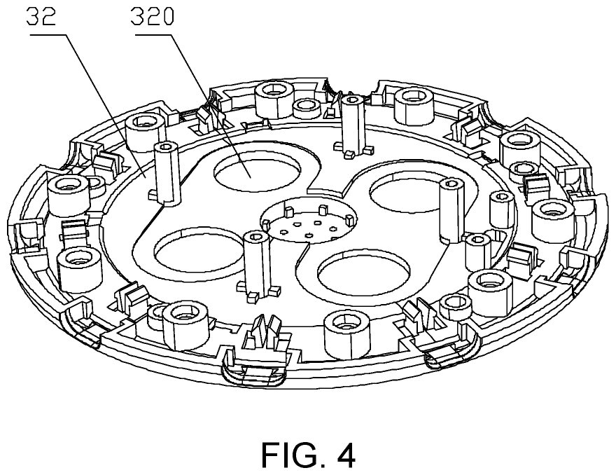

As shown in FIGS. 1-3, FIG. 1 is a schematic view of a head massager according to the present application, FIG. 2 is a schematic view of a first massage unit of a head massager according to the present application, and FIG. 3 is a cross-sectional view of a first massage unit according to the present application.

Referring to FIGS. 1-2, the present application provides a head massager, used for head massage. The head massager comprises a base component and a first massage component.

The first massage assembly comprises a plurality of first massage units, and each of the first massage units has a first connecting part 11 and a first massage part 12. One end of the first connecting part 11 is fixed to a side edge of the base assembly, and the other end of the first connecting part 11 is connected to the first massage part 12. A first vibration source 2 is encapsulated in the first massage part 12, and the plurality of first massage units are arranged in an annular array relative to a central axis of the base assembly. When the head is located among the first connecting parts 11, the first massage parts 12 fit and attach the head.

With the head massager of this embodiment, in the working process, when the user puts the head massager on the head, the head is located among the plurality of first connecting parts 11, and the plurality of first massage parts 12 fit and attach the head. The first vibration source 2 drives the first massage part 12 to perform vibration massage on the head, and the plurality of first massage parts 12 simultaneously perform vibration massage on the head. Each first massage part 12 has an independent first vibration source 2 for driving, and which working states do not affect each other. The cooperation of the plurality of first massage parts 12 can achieve the effect of fully massaging the head. The vibration intensity of the first vibration source 2 can be adjusted, which can be applied to users with different sensitivities to massage.

In the present embodiment, each first massage part 12 has an independent first vibration source 2 for driving, and which working states do not affect each other. The cooperation of the plurality of first massage parts 12 can achieve the effect of full massaging the head. The vibration strength and massage rhythm of each first massage part 12 can be adjusted, which can be applied to users with different sensitivities to massage.

In a specific embodiment, when the head is located among the plurality of first connecting parts 11, a curved surface of each of the first connecting parts 11 fits and attaches the head, which ensure that the first connecting parts 11 fit and attach the user's head, so that the head massager maintains a stable working state, and which can improve the massage effect on the user.

The base assembly comprises a shell assembled from an upper shell body 31 and a lower shell body 32, and a second massage assembly. The second massage assembly comprises a plurality of second massage units, and each of the second massage units has a second massage part 41 and a second connecting part 42 connected to the second massage part 41. The second massage part 41 is enclosed with a second vibration source, the lower shell body 32 has a number of through holes, the second connecting part 42 is encapsulated and fixed in the shell, and the second massage part 41 protrudes out from the shell. When the head is located among the first connecting parts 11, the second massage parts 41 fit and attach the top of the head. The plurality of second vibration sources drive the plurality of second massage parts 41 to massage the top of the user's head. At the same time, when the plurality of second massage parts 41 cooperate with the plurality of first massage parts 12 to massage the user simultaneously, the vibrations of the plurality of second massage parts 41 can drive and cooperate with the plurality of first massage parts 12 to move up and down to achieve better massage effect.

In other specific embodiments, each of the first connecting parts 11 comprises a hose 111 and a support rod 112. The support rod 112 is provided with a groove 1121, and the hose 111 is sleeved on the support rod 112 suitably, which is convenient to install a lead in the groove 1121 and fix the lead. When the first massage unit is working, the hose 111 has a vibration-reduction effect on the head when the hose 111 fits and attaches the head.

The support rod 112 is made of elastic material, which is suitable for users having different head type and head size, and at the same time plays the role of shock absorption.

The second massage unit is made of soft material. When the plurality of second massage parts 41 simultaneously massage the head, the soft material forms a buffer, which does not generate rigid vibration, and ensures a better massage effect.

The first massage part 12 has a massage surface 121 inclined to the head, and the inclination angle between the massage surface 121 and the central axis of the base assembly ranges from 5 to 10 degrees. When the first massage unit is working, the contact between the first massage part 12 and the head is surface contact, and the massage surface 121 inclined toward the head can closely fit and attach the head, which reduces the discomfort to the head in contact with the first massage part 12, and makes the massage effect better. Preferably, when the inclination angle is 7.5 degrees, the massage effect is the best.

The head massager in the present embodiment further comprises a control component fixed on the base component. The control component is electrically connected with the plurality of first vibration sources 2, for controlling the plurality of first vibration sources 2 to work independently. According to the user's needs, the first vibration source 2 within the area to be massaged can be activated to drive the first massage part 12 in the corresponding position to work.

The above is only the preferred embodiment of the present application, but the scope of protection of the present application is not limited thereto, and any equivalents or modifications of the technical solutions of the present application and the application concept thereof should be comprised in the scope of the present application within the scope of the technical scope of the present application.

1. A head massager for head massage, comprising: a base component and a first massage component;
wherein the first massage assembly comprises a plurality of first massage units, each of the first massage units has a first connecting part and a first massage part, one end of the first connecting part is fixed to a side edge of the base assembly, and the other end of the first connecting part is connected to the first massage part, a first vibration source is encapsulated in the first massage part, and the plurality of first massage units are arranged in an annular array relative to a central axis of the base assembly, when a head is adapted to be located among the first connecting parts, the first massage parts are attached to the head together.

2. The head massager according to claim 1, wherein when the head is adapted to be located among the plurality of first connecting parts, a curved surface of each of the first connecting parts fits and attaches the head.

3. The head massager according to claim 1, wherein the base assembly comprises: a shell assembled from an upper shell body and a lower shell body, and a second massage assembly, the second massage assembly comprises a plurality of second massage units, each of the second massage units has a second massage part and a second connecting part connected to the second massage part, a second vibration source is encapsulated in the second massage part, the lower shell body has a number of through holes, the second connecting part is encapsulated and fixed in the shell, and the second massage part protrudes out from the shell, when the head is adapted to be located among the first connecting parts, the second massage parts of the second massage units fit and attach a top of the head.

4. The head massager according to claim 1, wherein the first connecting part comprises a hose and a support rod, the support rod is provided with a groove, and the hose is sleeved on the support rod suitably.

5. The head massager according to claim 4, wherein the support rod is made of elastic material.

6. The head massager according to claim 3, wherein each of the second massage units is made of soft material.

7. The head massager according to claim 1, wherein the first massage part has a massage surface inclined to the head, and an inclination angle between the massage surface and the central axis of the base assembly ranges from 5 to 10 degrees.

8. The head massager according to claim 1, further comprising a control component fixed on the base component, the control component is electrically connected with the plurality of first vibration sources in the first massage parts for controlling the plurality of first vibration sources to work independently.
